(19) United States
(12) Patent Application Publication
(10) Pub. No.: US 2007/0230299 A1
(43) Pub. Date: Oct. 4, 2007

(54) Method of Partitioning Data on Data Carriers

(75) Inventors: Wiebe De Haan, Eindhoven (NL); Robert Albertus Brondijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,503

(22) PCT Filed: May 30, 2005
(86) PCT No.: PCT/IB05/51757

§ 371 Date: Nov. 22, 2006

(30) Foreign Application Priority Data
Jun. 3, 2004 (EP) 04102473.8

(51) Int. Cl. G11B 27/34; G11B 11/00; G11B 27/10

(52) U.S. Cl. 369/47.1

(57) ABSTRACT

There is described a method of partitioning data on a data carrier arranged to be a write-once item. The method comprises a first step of writing video data content to a first region of the carrier, a second step of writing other data content to a second region of the carrier, and a third step writing substantially mutually independent first and second directories for recording data layouts of their corresponding first and second regions respectively, for example during finalisation. Such partitioning of the video data content and other data content, for example still picture data, is of benefit in rendering the data carrier, for example implemented as a DVD R data carrier, more compatible with other data carrier formats, for example DVD RW.

### FIELD OF THE INVENTION

The present invention relates to methods of partitioning data on data carriers; in particular, but not exclusively, the invention concerns a method of partitioning data on write-once (R) data carriers to render them mutually compatible with repetitive read-write (RW) data carriers, for example for data copying purposes. Moreover, the invention also relates to apparatus arranged to record data onto write-once (R) data carriers in a manner utilising said methods of partitioning data.

### BACKGROUND TO THE INVENTION

Optical data carriers such as compact disks (CD's) and digital video disks (DVD) have now become widely employed for conveying image and video data on account of relatively large data storage capacity offered by these data carriers. These data carriers in overview are substantially circular planar components comprising one or more metal layers sandwiched integrally between first and second layers of substantially optically-transparent plastics material. Various chemical formulations for the one or more metallic layers can be employed depending on desired characteristics. For example the one or more metallic layers are made one-time recordable, as in contemporary DVD R disks; alternatively, the one or more metallic layers can be formulated to be user modifiable in response to laser irradiation for repetitively recording data thereon, as in contemporary DVD RW disks. Presently, in order to ensure compatibility of various manufacturers DVD data carriers and DVD apparatus, various standards have been defined, for example International Standard ISO 9660. In particular, the Optical Storage Technology Association (OSTA) is an organisation tasked with establishing standards for optical data storage technologies. Recognised standards include:

(a) DVD+R Physical Standard version 1.2:

(b) DVD+RW Physical Standard version 1.2;

(c) DVD+RW Video Standard version 2.0 (DVD+VR for DVD RW);

(d) MMC4 version e Standard

(e) UDF 1.5

(f) DVD+R Video Standard version 1.2 (DVD+VR for DVD R)

These standards (a) to (e), amongst others, define layouts for data structures recorded on DVD data carriers to render them compatible with contemporary commercial DVD read/write apparatus.

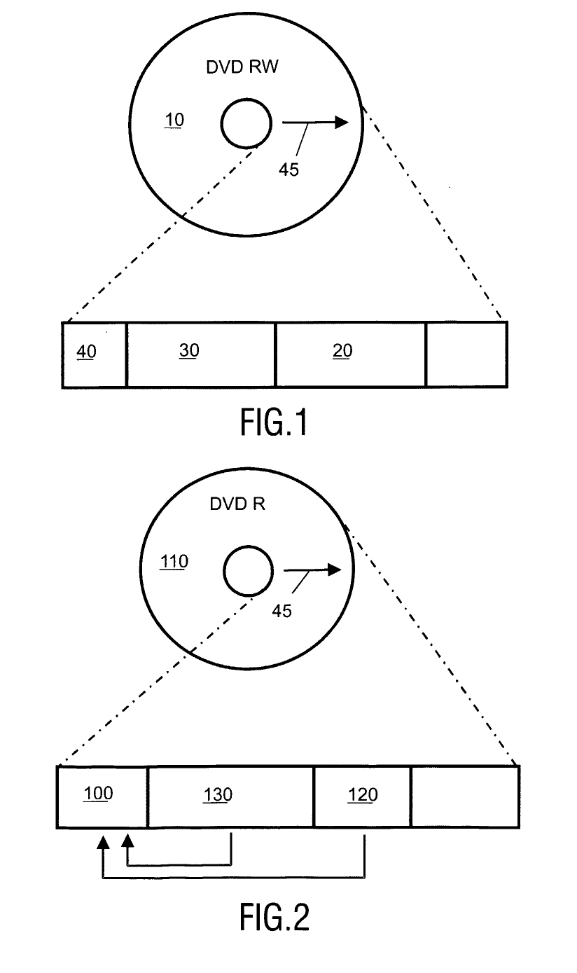

Currently, with reference to FIG. 1, it is possible to combine video with still pictures on a single optical disk data carrier 10, for example a DVD RW disk data carrier conforming to the standard (b) above. Data structures for such a data carrier are defined in the standard (c) above, these structures being arranged to render data stored on the data carrier 10 editable. In order to support editing, picture data is recorded on a separate area of the disk data carrier relative to video data, namely the picture data is stored at an end region 20 of the disk carrier 10 after a preceding region 30 allocated to the video data. Directory information is included at an initial region 40 of the disk carrier 10, this region 40 being left blank for receiving directory data indicative of where items of video and picture data content are recorded on the carrier 10. Subsequent updating of data content on the data carrier 10 is achieved by overwriting the initial region 40. An arrow 45 denotes writing direction from a first storage track of the carrier 10 to a last storage track thereof.

Such separate data structures are described in a published United States patent application no. US2003/0210895 with regard to DVD RW data carriers. In this application, there is elucidated a DVD RW data carrier wherein a DVD video file recorded thereon is managed according to a provisional video manager (VMGI), for example according to TMP_VMGI. Moreover, the DVD RW data carrier also includes an extension file other than a DVD video file which is managed according to intermediate management information, for example according to TMP_EXTI; the extension file includes, for example, JPEG encoded image data content. Furthermore, there is provided a temporary space bitmap, namely TMP_SBM, used for universal disk format (UDF) purposes which is added to the provisional video manager (VMGI) to record a combination of the DVD video file and the extension file and also manage the temporary space. By employing such a data structure, the temporary space can be known from a temporary space bitmap (TMP_SBM), even when the extension file has been deleted; thus, the DVD RW data carrier is rendered compatible with DVD R through finalisation. By this approach, a file of still pictures other than moving pictures can be recorded in a file on a DVD RW data carrier together with pad information in a temporary space resulting from deletion of any recorded area of the data carrier.

### SUMMARY OF THE INVENTION

The inventors have appreciated that there are presently two data formats in use for DVD data carriers.

A first data format is known as “video mode” which is employed for both DVD RW and DVD R types of data carrier. Programme content recorded in video mode is stored on a DVD RW or DVD R data carrier as a video title set (VTS) each including one <>.ifo file, one or more <>.vob files and one <>.bup file. On such data carriers, data content corresponding to still pictures is susceptible to being recorded between such VTS's; when such recording of still pictures occurs, data formats employed for DVD RW and DVD R data carriers are substantially similar. Thus, still picture data and VTS's can occur in an interleaved manner.

A second data format is known as “DVD+VR” in which partial overwrites and deletions of data content are possible. When the second data format is employed for DVD R data carriers, finalisation is required after data content is modified to ensure representative directory records are maintained. Moreover, on account of a linear recording space provided on such DVD R and DVD RW data carriers, data content corresponding to still pictures added to the data carriers are preferably recorded in a separate area thereof. Processes for overwriting and deletion of data content have been defined for DVD RW type of data carriers where a data section is optionally recorded following a video section. However, such processes for DVD R data carriers have not yet been defined on account of difficulties associated with a way in which incremental updates are realised for DVD R data carriers.

Thus, differences between DVD R and DVD RW data carriers are encountered when making updates of data content to such data carriers, for example with regard to menu updates and finalisation procedures. These differences, for example, render it non-trivial when copying data from one of these data carrier type to another.

The inventors have envisaged that it is desirable to employ a form for data structures in DVD R data carriers which is as similar as possible to DVD RW carriers for two principal reasons:

(a) reuse of software components becomes possible and implementation is more straightforward in practical disk drive hardware; and

(b) when data contents of a finalised DVD R data carrier are copied to a DVD RW data carrier, data becomes available for editing again so there is no difference between the characteristics of DVD R data carriers in comparison to those of DVD data carriers.

An object of the present invention is therefore to provide a data structure for DVD R type of data carriers which is more compatible with DVD RW type of data carriers.

According to a first aspect of the present invention, there is provided a method of partitioning data on a data carrier arranged to be a write-once item, the method including steps of:

(a) writing video data content to a first region of the carrier;

(b) writing other data content to a second region of the carrier; and

(c) writing substantially mutually independent first and second directories for recording data layouts of their corresponding first and second regions respectively.

The invention is of advantage in that use of the first and second directories enables the video data content to be more clearly distinguished from other types of data content, for example still picture data, thereby rendering it unnecessary to update both directories when additional data content is added to the write-once data carrier.

Preferably, the method includes a step of combining the first and second directories when the video data content and the other data content are to be finalised on the data carrier.

Preferably, the method includes a step of arranging for the first and second regions to be mutually spatially distinct on the data carrier. Such partitioning circumvents aforementioned data-type interleaving which renders conventional write-once data carriers incompatible with DVD+VR data structures used on DVD RW types of data carrier. More preferably, the data carrier is a DVD R write-once item.

Preferably, the method comprises a step of including a reserved space allocation table (RSAT) function for describing data structures of the first region and UDF information for describing data structures of the second region. RSAT is described in a published United States patent application no. US2003/0068159 which is hereby incorporated by reference with regard to RSAT. Writing video and data content details onto different types of directory format on the write-once data carrier renders the data carrier more widely compatible with contemporary data carrier reading apparatus. Preferably, in step (c) of the method, the data carrier is arranged to be closed by creating a directory of contents for the first region using a RSAT function, and creating a directory for the second region using UDF information.

Preferably, the first region is designated as substantially a single large video file.

Preferably, in the method, the first and second directories are mutually independently writable.

According to a second aspect of the invention, there is provided a data carrier including video data content and other data content recorded thereon according to the method of the first aspect of the invention.

According to a third aspect of the invention, there is provided an apparatus for recording data on a write-once data carrier, said apparatus arranged to write data on the data carrier according to the method of the first aspect of the invention.

It will be appreciated that features of the invention are susceptible to being combined in any combination without departing from the scope of the invention.

### DESCRIPTION OF THE DIAGRAMS

Embodiments of the invention will now be described, by way of example only, with reference to the following diagrams wherein:

FIG. 1 is a schematic diagram of video and still picture data content file allocation on a DVD RW disk data carrier;

FIG. 2 is a schematic diagram of a DVD R data carrier having recorded thereon both still picture data and video data;

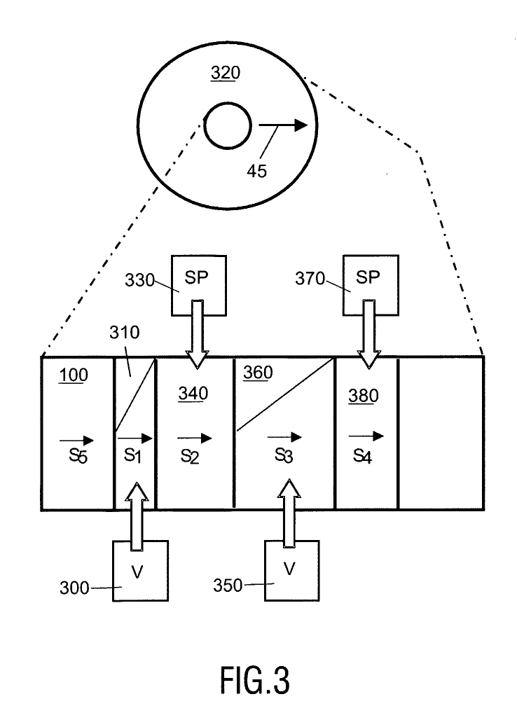

FIG. 3 is a schematic diagram of a DVD R data carrier having interleaved video data and still picture data;

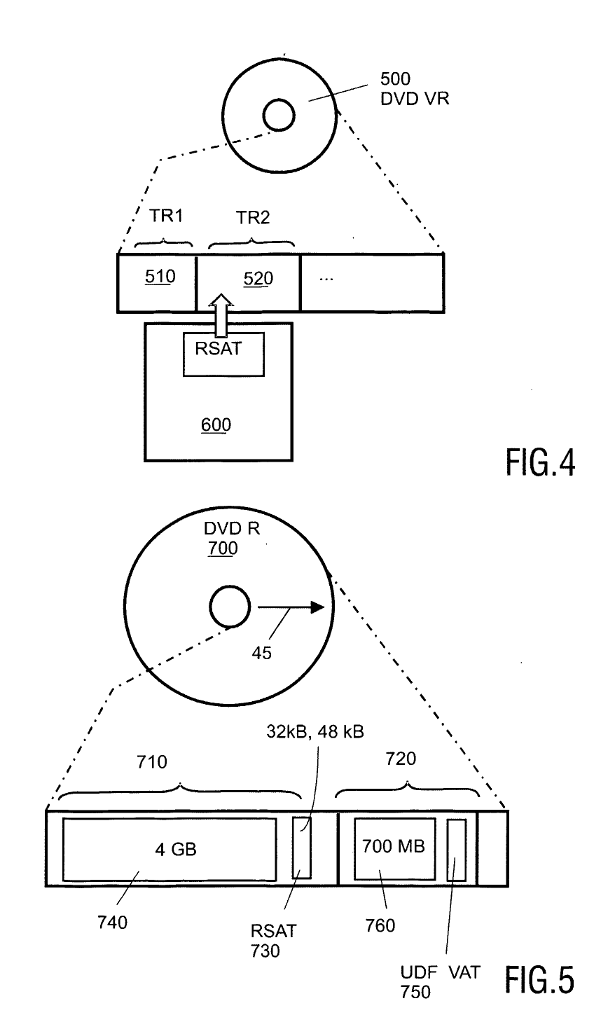

FIG. 4 is a representation of a DVD+VR data carrier for receiving a RSAT function;

FIG. 5 is a data layout for a DVD R data carrier suitable for rendering it easily susceptible to being copied to a DVD RW data carrier; and

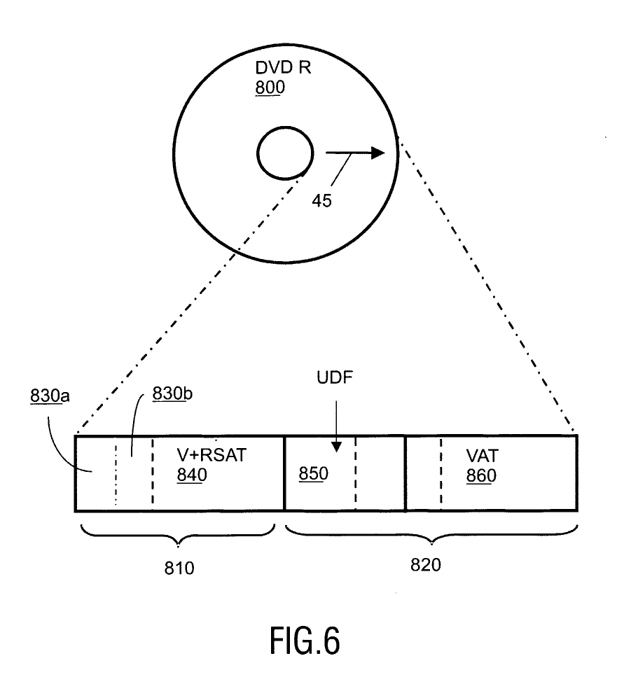

FIG. 6 is an example of data partitioning in a write-once DVD R data carrier according to the invention.

### DESCRIPTION OF EMBODIMENTS OF THE INVENTION

In overview, the inventor has envisaged that it is desirable to employ compatibly similar data structures for both DVD R as well as DVD RW data carriers. As data layout for DVD R data carriers has already been established by way of international agreement, for example by way of OSTA, the inventors have identified that it is advantageous to digress from established practice for DVD R data carriers in devising the present invention.

As described in the foregoing, it is conventional practice to interleave video data content and still picture content of DVD R data carriers. On account of its write-once characteristic, it is not possible to overwrite a directory region on a DVD R data carrier. Thus, an initial region 100 of a DVD R data carrier 110 shown in FIG. 2 is maintain blank so that it can hold a final copy of the data carrier 110 contents once these contents have been finalised by way of finalisation. Until data carrier content details are written into the initial region 100, the data carrier 110 is referred as being in an “open” state. In order to update contents of the data carrier 110, additional data content is appended to a subsequent region 120 from an existing region 130 where existing data content has been written.

For example, in FIG. 3, a user initially records video data content (V) 300 in a first region 310 of a DVD R data carrier 320 in a stage S1. Subsequently, in a stage S2, the user adds some still picture data content (SP) 330 which is appended in a second region 340 after the first region 310. Thereafter, in a stage S3, the user adds further video data content (V) 350 in a third region 360. Next, the user appends still picture data content (SP) 370 in a fourth region 380 after the third region 360. Finally, the user causes the directory record of the regions 310, 340, 360, 380 to be written to the initial region 100 of the data carrier 320 by way of finalisation. It will be appreciated that data content on the DVD R data carrier 320 is in an interleaved manner with regard to video (V) and still picture (SP) in contrast to FIG. 1 where distinct separate video and data regions are allocated.

There is a present DVD+VR standard which adopts a data carrier 500 as depicted in FIG. 4; the standard pertains to write-once data media. The data carrier 500 includes a first track 510 (TR1) of 32 Mbytes capacity and a second track 520 (TR2) in which video data content is written; the second track 520 is not visible on account of it being an incomplete fragment. Recording apparatus 600 is arranged to include a reserved space allocation table (RSAT) function, for example as described in a published United States patent application no. US 2003/0068159 which is hereby incorporated by reference with regard to RSAT. On the data carrier 500, an RSAT is a small table written at an end of an incomplete fragment after each append. Moreover, the RSAT contains a mapping of blocks temporarily written in the incomplete fragment destined to be written to the first track 510 when the data carrier 500 is finalised. Aforementioned VMG, VTSI, UDF and ISO data are amongst the data that is thereby reallocated.

In order to improve compatibility of DVD R data carriers in comparison to DVD RW data carriers, the inventors have appreciated that it is desirable when recording data content onto such a DVD R data carrier to partition data structures of the carrier into mutually distinct video and data parts. For example, a write-once DVD R data carrier 700 depicted in FIG. 5 is partitioned into a video part 710 and a data part 720; the data part 720 is, for example, susceptible to being used to record still picture data content such as JPEG files. Moreover, each part 710, 720 is arranged to keep a directory record of its own portion of the data carrier; thus, the video part 710 has RSAT data 730 at the end of video data content 740 stored therein, whereas the data part 720 has a universal disk format (UDF) virtual allocation table (VAT) 750 appended at the end of data content 760 stored therein as illustrated. Typically, the video data content 740 has a size in the order of 4 GBytes whereas the data content 760 is in the order of 700 MBytes in size. The RSAT data 730 and the allocation table 750 are in comparison considerable smaller; for example, the RSAT data 730 is preferably less than 100 kbytes in size, and more preferably 32 kBytes or 48 kBytes in size to accommodate many small updates as required.

If the data carrier 700 and its associated data structures are interrogating disregarding data content stored therein, the carrier 700 complies with contemporary DVD+VR 1.2 standards. Moreover, the data part 720 appears similar to contemporary UDF1.5 standards and their approach to coping with DVD R data carriers with an end secondary anchor pointer pointing towards a VAT directory table. This VAT table only describes the data part 720 of the carrier 700, namely it does not relate to the video part 710. In consequence, the VAT table does not need to be updated every time the RSAT function 730 is updated, otherwise the VAT table would rapidly be saturated with data. Thus, the VAT table preferably describes the video part 710 as one large file. The inventor has therefore envisaged that implementation of the parts 710, 720 on a DVD R data carrier requires there to be available five open tracks as depicted in FIG. 6.

Optionally, it is possible to use just four open tracks. In this case, a file system for the data part 720 is written into the video part 710 or partly after the data part 720 when finalised. As a further option, one or more additional tracks can be included between the first and video part 710 and the data part 720.

In FIG. 6, a DVD R data carrier 800 includes a video data content section 810 and thereafter a data section 820. The video section 810 includes first track regions 830a, 830b followed by a second track region 840. The track region 830b is included for recording a first UDF anchor (AVDP). In practice, the track regions 830a, 830b are preferably collectively in the order of 1 Mbytes in size. Moreover, the data section 820 includes a third track region 850 and a fourth track region 860. The second track region 840 is arranged to include video content data together with a RSAT function (V+RSAT). Additionally, the fourth track region 860 is arranged to include data together with a VAT table (VAT). When the data carrier 800 is either to be “finalised” or “closed”, the sections 810, 820 are processed as follows:

(a) the RSAT function is used to create a directory of contents for the first track regions 830, namely contemporary VMG, VTSI's, UDF and ISO structures as appropriate; and

(b) in the data section 820, the third track region 850 is written with proper UDF information reflecting status of the fourth track region 860.

The RSAT function cannot be directly applied to write the first track regions 830a, 830b as at least some of the pointers must be included in the second part of filing system information included in the third track region 850.

In conclusion, in a context of write-once data carriers, for example DVD R type data carriers, the invention concerns a plurality of spatially distinct data regions wherein one of the regions is designated for video content and another of the regions is designated for data such a still pictures and images. Each of the regions is provided within its own directory fields, these fields only relating to their associated corresponding regions. In other words, each region is preferably provided with its own directory facilities.

In the accompanying claims, numerals and other symbols included within brackets are included to assist understanding of the claims and are not intended to limit the scope of the claims in any way.

It will be appreciated that embodiments of the invention described in the foregoing are susceptible to being modified without departing from the scope of the invention as defined by the accompanying claims.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed to be a reference to the plural and vice versa.

1. A method of partitioning data on a data carrier arranged to be a write-once item, the method including steps of:
(a) writing video data content to a first region of the carrier;
(b) writing other data content to a second region of the carrier; and
(c) writing substantially mutually independent first and second directories for recording data layouts of their corresponding first and second regions respectively.

2. A method according to claim 1, including a step of combining the first and second directories when the video data content and the other data content are to be finalised on the data carrier.

3. A method according to claim 1, including a step of arranging for the first and second regions to be mutually spatially distinct on the data carrier.

4. A method according to claim 1, wherein the data carrier is a DVD R write-once item.

5. A method according to claim 1, comprising a step of including a reliability and system architecture testing (RSAT) function for describing data structures of the first region and UDF information for describing data structures of the second region.

6. A method according to claim 1, wherein the first region is designated as substantially a single large video file.

7. A method according to claim 1, wherein the first and second directories are mutually independently writable.

8. A data carrier including video data content and other data content recorded thereon according to the method of claim 1.

9. An apparatus for recording data on a write-once data carrier, said apparatus arranged to write data on the data carrier according to the method of claim 1.
